(19) United States
(12) Patent Application Publication
(10) Pub. No.: US 2006/0037407 A1
(43) Pub. Date: Feb. 23, 2006

(54) Device for measurement of mass flow velocity and method of use

(75) Inventors: Georg Brasseur, Vienna (AT); Anton Fuchs, Graz (AT)

Correspondence Address: MONTE & MCGRAW, PC, 4092 SKIPPACK PIKE, P.O. BOX 650, SKIPPACK, PA, 19474, US

(73) Assignee: Technische Universitat Graz, Graz (AT)

(21) Appl. No.: 11/246,844

(22) Filed: Oct. 7, 2005

(30) Foreign Application Priority Data
Apr. 7, 2004 (WO) PCT/AT04/00123
Apr. 10, 2003 (AT) A 562/2003

(51) Int. Cl. G01F 1/58

(52) U.S. Cl. 73/861.12

(57) ABSTRACT

A method and a device for determining the velocity of a mass flow of powdered/granular bulk material in a conduit (1). Periodic disturbances are introduced into the mass flow that affect its electrical properties at at least one first point of the conduit (“point of disturbance”) (SST). Using an electrode mechanism (ME1 . . . ME6) an electrical current is produced by the mass flow at at least one second measuring point situated downstream of the point of disturbance (“measuring point”) (MST), and temporarily occurring changes of the current based on the disturbances introduced upstream are measured via an evaluation circuit (REV). The speed of the mass flow is determined from the time dependency between measured changes and introduced disturbance.

### CROSS-REFERENCE TO RELATED APPLICATIONS

This application claims priority from PCT Application No. PCT/AT2004/000123 filed Apr. 10, 2004 which claims priority from Austrian Application No. A 562/2003 filed Apr. 10, 2003.

### FIELD OF THE INVENTION

The invention relates to measurement apparatus and methods, and more particularly to a device and a method for determining the velocity of a mass flow comprising a powdery/granular bulk material inside a conduit.

### BACKGROUND OF THE INVENTION

Many methods and corresponding devices for measuring the flow velocity of a mass flow have become known. For example, German patent application 40 25 952 A1 describes the measurement of the flow velocity of fine-grain bulk material within a pneumatic or hydraulic suspension via a contactless measurement using capacitive sensors. In this context, two encoder electrodes of a sensor electrode are physically situated opposite each other on the outer side of a measuring tube, an alternating current being applied to the encoder electrodes in phase opposition. Two encoder electrodes and one sensor electrode are again provided downstream or upstream, the feed being accomplished in this context using a different frequency. Using phase-sensitive rectifiers and signal conditioning via cross-correlation, static fluctuations are detected and from them the flow velocity is deduced. A similar measuring system having two electrode pairs is known from German patent application 39 09 177 A1. Just as in the aforementioned document, the detection and evaluation of static fluctuations of the mass flow, in this case coal dust, is accomplished after strong signal amplification using phase-sensitive rectifiers and a propagation time correlator.

A measuring system described in WIPO patent application 01/65212 A1 uses two annular capacitive sensors surrounding a flow tube that are set at a distance from each other, each having at least three electrodes. Flow parameters are acquired by detection of capacitive changes at the two sensors and cross-correlation. What is disadvantageous in these known measuring methods is the high level of effort required for signal evaluation due to what are often only very small fluctuation signals, especially if the method is to be used under actual industrial conditions.

In German patent application 30 49 019 A1, a method is described in which the bulk material is fluidized and two signals whose timing interval is established are derived from a marking that is impressed on the bulk material (e.g., an air pulse injected through a valve) via two electrodes that are located at the beginning and at the end of a prescribed distance. Unless this method requires a fluidization of the bulk material, this method requires the use of two electrodes at different locations that are both different from the introduction plane of the disturbance.

The measurement in the case of powdery/granular bulk material broadly speaking represents a special problem. While there are many sometimes very different, yet precise and satisfactorily working methods for measuring the flow velocity of fluids and gases, this is not the case in particular for bulk materials that have an abrasive action, such as a cement/air flow, especially in this case invasive methods, e.g., electrodes in the mass flow, cannot be used.

One object of the invention is to provide a method and a measuring system that are appropriate for practical application and also provide acceptable measured results, even in a difficult environment. In this context, the number of measured values per time unit is supposed to be great enough to be able to detect changes in the transport speed of the mass flow quickly enough.

### BRIEF SUMMARY OF THE INVENTION

This objective is achieved using a method of the type mentioned at the outset, in which according to the invention periodic disturbances are introduced into the mass flow that affect its electrical properties at at least one point of disturbance on the conduit, using an electrode mechanism a current through the mass flow is produced at at least one measuring point situated downstream of the disturbance point, temporarily occurring changes of the current based on the disturbances introduced upstream are measured via an evaluation circuit, and the velocity of the mass flow is determined from the time dependency between measured changes and introduced disturbance.

The invention takes advantage of the fact that the introduced disturbances—in contrast to disturbances that occur randomly—are indeed known with respect to both the location and the instant of its occurrence, which makes the measurement and evaluation substantially easier than relying on statistical disturbances. Even a measurement without application of correlation methods is possible. In contrast to German patent application 30 49 019 A1, the placement of electrodes at multiple points is not required (naturally, the measurement of multiple points may produce a higher precision) because the signal is always evaluated in relation to the point of disturbance and not in relation to the difference between two measuring points.

It is advantageous if the introduced disturbances affect the complex conductivity of the mass flow, and this is determined using the electrode mechanism and the evaluation circuit at the at least one measuring point because proven methods and devices for measuring the complex conductivity are available to one skilled in the art. In this context, it may be provided in particular that at the point of disturbance a medium is introduced in the mass flow whose conductivity noticeably deviates from that of the bulk material, or the introduced disturbances lead to a local change of the dielectric constant of the mass flow.

Depending on the type of bulk material, one may also advantageously provide that an electric disturbance field strength is produced at the at least one point of disturbance. In this context, the field strength may be selected to be great enough that periodic discharges occur. It is also expedient if a displacement current is measured using the electrode mechanism and the evaluation circuit at the at least one measuring point. It has been demonstrated in practice if the frequency of the measured alternating current is within the range of 10⁶ to 10⁹ Hz, because in this range the measurements may be carried out with good precision and without too great an effort.

The objective is also achieved via a device for carrying out the inventive method cited above along with its variants, the device being characterized by a measuring section of a conduit in which at at least one point of disturbance a device is provided for introducing periodic disturbances that affect the electrical properties of the mass flow; and an electrode mechanism that is connected to the evaluation circuit is provided downstream of the point of disturbance at at least one measuring point. To increase the measuring accuracy and sensitivity, it may be expedient if an electrode mechanism is provided at each of at least two measuring points that are situated spaced apart from each other in the direction of flow.

In an advantageous variant it is provided that the electrode mechanism has at least one electrode pair. A further refinement of the measurement may be achieved if the electrode mechanism of each measuring point has at least two electrode pairs. In the case of metallic conduits or pipes, a possible and expedient variant is comprised by the fact that an electrode of the electrode mechanism is formed by the conduit wall or a section of the conduit wall.

What is especially advantageous, because it requires no interventions in an existing conduit, is a design in which the electrodes of the electrode mechanism are disposed on the exterior side of an insulated tube that forms the conduit. A recommendable variant provides that a separate evaluation circuit is provided for the electrode mechanism of each measuring point. On the other hand, it may be expedient in many cases if electrode pairs of different measuring points are connected in parallel and are connected to a common evaluation circuit.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIGS. 1a and 1b are a side view and a section view that diagrammatically show a conduit through which a mass flow circulates and which has measuring electrodes and an introduction of a disturbance for carrying out the method of the invention;

FIGS. 2a and 2b are views like FIGS. 1a and 1b and show the propagation of an introduced disturbance in the direction of flow;

FIG. 3 shows a schematic section similar to FIG. 1b supplemented with a measuring system according to the invention;

FIG. 4 is a time diagram that shows the periodic, successive, circumferentially offset introduction of disturbances on the basis of the corresponding control signals;

FIGS. 5a to 5i are similar to FIGS. 1b and 2b show the spread of a disturbance in a tube viewed in an axial direction when there is an introduction of disturbances that is offset in terms of time and a circumferential angle of 120°;

FIG. 6 shows the measuring sequence in a block diagram;

FIG. 7 shows curves of the signals of the measuring electrodes over time; and

FIG. 8 shows the center-of-mass formation on one of the signals of FIG. 7.

### DETAILED DESCRIPTION OF THE INVENTION

In the drawings, like numerals indicate like elements throughout. In the drawings, like numerals indicate like elements throughout. Certain terminology is used herein for convenience only and is not to be taken as a limitation on the present invention. The embodiments illustrated below are not intended to be exhaustive or to limit the invention to the precise form disclosed. These embodiments are chosen and described to best explain the principle of the invention and its application and practical use and to enable others skilled in the art to best utilize the invention.

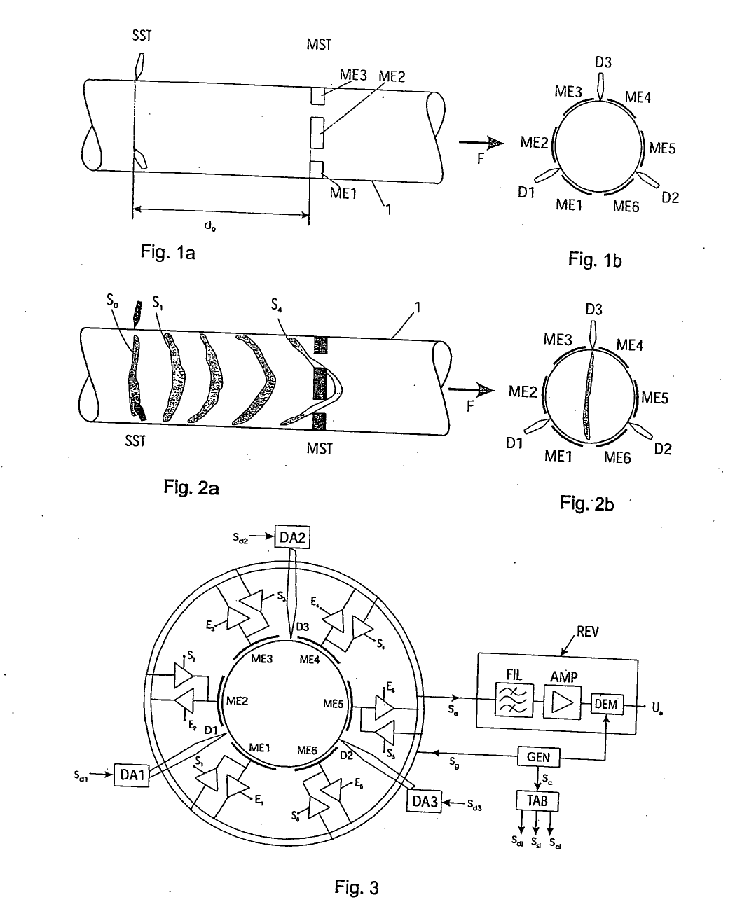

FIGS. 1a, 1b show a measuring section of a conduit LTG that is made of plastic, for example, and through which a mass flow in the direction of arrow F occurs. This may involve, for example, granular or powdered material that is transported suspended in air or in another gas. Examples are grain, flour, coal dust, cement, and so forth.

At a point of disturbance SST, a disturbance may be introduced into the mass flow that affects or changes the electrical properties of the mass flow. Circumstances permitting, water may be injected into the mass flow using, for example, nozzles D1 . . . D3 disposed about the circumference of the conduit 1 at angular intervals of 120°. This is possible, for example, in a concrete mixing plant in which cement dust is supplied via compressed air. Using the invention, the transport velocity and, via the known or to-be-determined mass density of the transport flow, the mass flow per time unit are determined. The injection of water, which in some cases may be easily acidified, leads to a strong local increase of the conductivity.

In this example, six measuring electrodes ME1 . . . ME6 are disposed at a distance downstream of the flow point SST at a measuring point MST on the circumference of tubular conduit 1, e.g., glued outside on tubular conduit 1 at, for example, angular intervals of 60°. The measuring electrodes ME1 . . . ME6 may be interconnected in various ways, it being essential that the displacement current be measured by a capacitor using an evaluation or measuring device and its dielectric be at least in part the mass flow in the pipeline. Of course, in the simplest case two electrodes, i.e., an electrode pair, at the measuring point are sufficient.

Regarding the configuration and arrangement of the measuring electrodes, many variants are possible. If the conduit or the pipe is not made of plastic or another insulating material, but instead is made of metal, the tube wall may form an electrode and one or more electrodes must then be insulated in an appropriate manner from the metallic tube and be able to cooperate with the tube as counter-electrodes.

FIGS. 2a and 2b show the continuation of a flow S, which is produced downstream, for example, by injection of a jet of water at the point of disturbance SST as disturbance S₀, after a certain time downstream in flow direction F as disturbance S₁ and finally at the measuring point as an already heavily distorted disturbance S₄. The distortion is a result of the inconsistent speed profile of the disturbance over the cross-section of conduit 1.

It should be noted here that it is possible to carry out measurements of the flow even at two or more measuring points in order to increase the precision of the measurement. A possible evaluation circuit for the method of the invention is described below in relation to FIG. 3. A generator GEN supplies a high-frequency transmission signal to feed the electrodes ME1 . . . ME6 and in some cases also clock signals s_{di}, sₛᵢ, sₑᵢ that are used in the manner described later to trigger switching operations. The aforementioned clock signals may be generated in a clock-conditioning circuit TAB, starting from a clock timing circuit s_{c} supplied by generator GEN. On the other hand, a sensing circuit REV is provided that contains a filter FIL, a demodulator DEM and in some cases an amplifier AMP and that supplies an output signal sₐ that supplies the speed of the mass flow after appropriate processing.

Control switches E₁, S₁, . . . , E₆, S₆ enable receiving and transmitting electrodes from the six electrodes ME1 . . . ME6 to be triggered, i.e., selected. Control switches Eᵢ, Sᵢ are triggered by the clock signals sₛᵢ and sₑᵢ, the signals sₛᵢ and sₑᵢ having complementary values, i.e., being inverted in relation to each other, so that each switch Sᵢ is switched on and the associated switch Eᵢ is switched off, and can either be transmitted or received at an electrode MEᵢ. In connection with FIG. 3, it is evident that in the case of transmission the transmission signal s_{g} is applied directly to an electrode MEᵢ, whereas in the case of reception the signal sₑᵢ received at the electrode is switched through at the reception circuit REV.

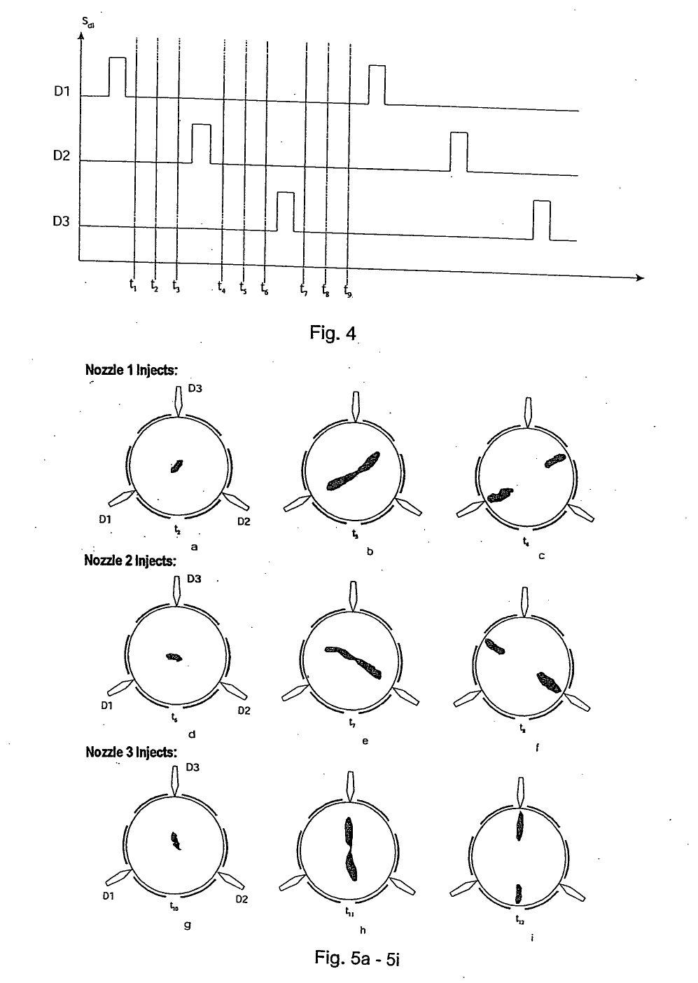

In the case of the shown exemplary embodiment and time-offset drive signals STI for the disturbance drivers DA1, DA2, DA3, e.g., solenoid valves in the case of a fluid injection, a relatively homogeneous stream of material to be conveyed is assumed. According to FIG. 4 at instant T1, nozzle D1 receives a control signal for the disturbing injection that is introduced into the stream of material to be conveyed in the form of a bundled water jet. As the edge of the control signal for nozzle D1 increases, a meter is simultaneously started, and the electrode controller switches measuring electrode ME1 to “transmit” and all other electrodes to “receive”. This occurs using signals sₛᵢ and sₑᵢ of the clock-conditioning circuit TAB, switch S1 then being active, switch E1 inactive, switches S2 to S6 inactive and switches E2 to E6 active. If the disturbance S has not yet reached the measuring point MST or its reception range, the amplitudes of the reception signals at the individual reception electrodes change only slightly due to the natural statistical fluctuations that occur in the stream of material to be conveyed and may be regarded as approximately constant.

As already shown in FIG. 2a, the disturbance SST that is introduced at the point of disturbance is carried off by the speed of the stream of material to be conveyed and thereby also undergoes a rheological breakdown according to the speed profile that is prevalent in the tube.

If the disturbance is effective through nozzle D1 at measuring point MST, the field strength darts exiting from (transmission) electrode ME1 change due to the effect of the disturbance. At (reception) electrode ME2, a higher potential is achievable than in the undisturbed state, whereas the measured potential will be smaller at (reception) electrode ME6. Because of the dielectric constant of the disturbance, which in the present case is high, fewer field lines go from (transmission) electrode ME1 to (reception) electrode ME6 because more field lines with the preferred direction go to (reception) electrode ME2 due to the resulting anisotropy. In reference to FIGS. 5a to 5i, it is evident that not the entire disturbance is effective at the same instant at measuring point MST. Due to the speed profile prevailing in tube or conduit 1, there are parts that are conveyed more quickly in the center of the tube and more slowly at the perimeter of the tube. Particles of, for example, cement dust that are affected by the disturbance and have a relative dielectric constant of approximately 80 and which are further away from electrodes, because of the distribution of sensitivity of the shown electrode configuration, have less influence on the reception signals than disturbed particles close to the edge of the tube. For each area in the conduit cross-section in which disturbed particles are found, a potential distribution clearly results at electrodes ME1 to ME6. If one knows the rheological model that describes the breakdown of the disturbance in the tube and one has data regarding the type of disturbance (e.g., form of the jet, injection quantity and injection depth), then this potential assignment is unique and supplies a speed profile of the bulk material transported in the conduit even when only a single measuring plane is used.

Depending on the type of bulk material, one may also advantageously provide that an electric disturbance field strength is produced at the at least one point of disturbance. In this context, the field strength may be selected to be great enough that periodic discharges occur. It is also expedient if a displacement current is measured using the electrode mechanism and the evaluation circuit at the at least one measuring point. It has been demonstrated in practice that, if the frequency of the measured alternating current is within the range of 10⁶ to 10⁹ Hz, the measurements may be carried out with good precision and without too great an effort.

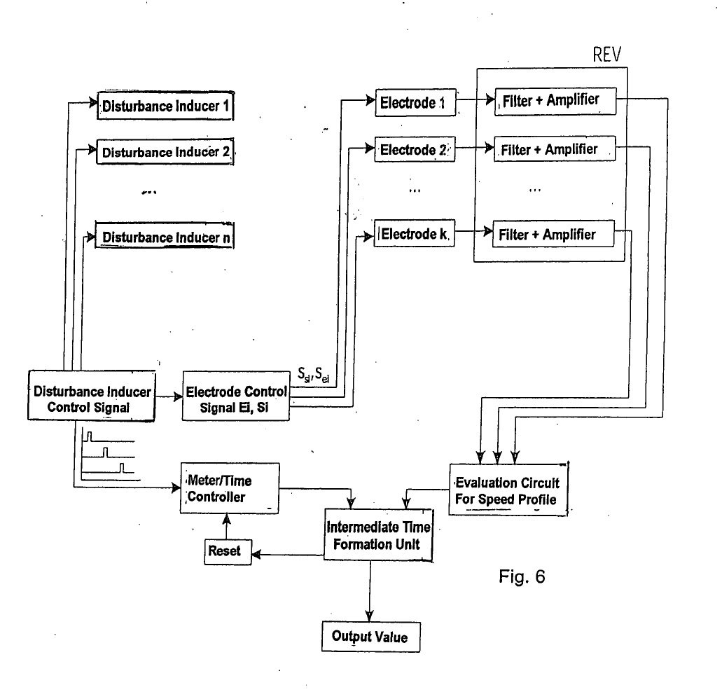

FIG. 6 shows a block diagram to facilitate understanding of the method of the invention. With “disturbance inducers” the nozzles are marked for the specific case of an injection, but broadly speaking disturbances may be introduced that affect the electrical properties of the mass flow. This may also involve, for example, electrical discharges. The disturbance inducer control signal is the signal for triggering the nozzles that is labeled s_{di} in FIG. 3, the triggering of the actual electrode control using signals sₛᵢ and sₑᵢ being derived in FIG. 6 from the block labeled “disturbance inducer control signal”.

If the measured potential is detected at each reception electrode for the particular meter state of the meter marked in FIG. 6, then the average transport speed at which the speed profile is considered in conduit 1 results at the time via center-of-mass formation. Likewise, in the evaluation circuit for speed profile shown in FIG. 6 the latter is calculated, the filtered and amplified demodulated reception signals of the electrodes on the one hand and the meter state on the other hand being supplied as input quantities to the evaluation circuit.

The meter is reset if the potential values of the reception electrodes fall back to a level of the undisturbed distribution. The timing control is calculated in such a manner that shortly thereafter the control signal for jet D2 will occur and this nozzle will inject. As is evident from FIG. 4, if nozzle D2 is triggered at instant t₅, it injects the disturbance into the stream of material to be conveyed and at the same time the meter is started and electrode ME5 is switched to “transmit”, all other electrodes being simultaneously switched to “receive”. This was already explained in connection with the electrode acting as a transmission electrode in E1. The disturbance will spread back out, and in the manner described above there is a new measurement.

At instant t₉ the described operations logically run their course with triggered nozzle D3 and electrode ME3 as the single transmission electrode of the configuration, whereas all other electrodes are in the receive mode. After that, the entire measuring cycle repeats, beginning again with nozzle D1.

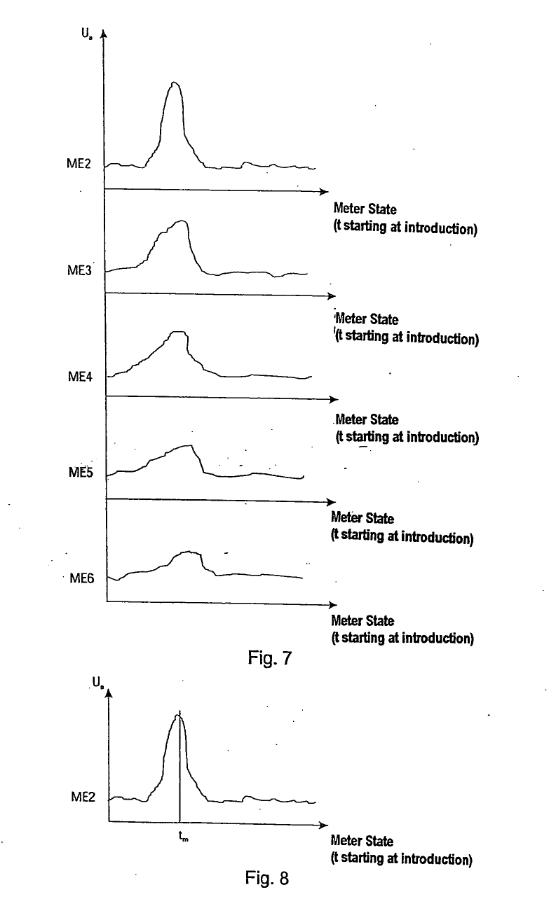

Signals sₑᵢ of the measuring electrodes that are fed to the evaluation circuit for the speed profile may have a curve as shown in FIG. 7 when measuring electrode ME1 is wired as the transmission electrode. On the ordinate, the signal curve of the received voltage signal after the reception circuit REV is represented as a function of the meter state. The highest signal level is available on measuring electrode ME2—in this case a disturbance on the edge of the tube has especially great influence on the received signal. The most information about the entire cross-section is obtained at measuring electrode ME4 (opposing electrode of the transmission electrode)—even particles that are conveyed faster in the center of the tube are situated between transmission and reception electrodes in this system and thereby affect the reception signal in the event of a disturbance.

If the received voltage values of reception electrodes ME2 . . . ME6 are recognized at each state of the meter, then it is possible to reckon back to the distribution of the particles affected by the disturbance. A second possibility would be the specification of known disturbance profiles: at each instant (or meter state) tᵢ, the values of the five reception electrodes in this case are picked up. These five values are compared to values of known profiles and a distribution is approximated (best fitting). The speed profile is determined via the change of this distribution over time.

For the determination of the average transport speed, a center-of-mass formation of the reception signal is carried out. Due to the resetting of the meter at the instant the disturbance is introduced, the meter state when the disturbance occurs in the measuring point is a measure for the time in which the disturbance has moved the defined section (d₀) further. An averaging (center-of-mass formation) enables the measurement of the average transport speed. FIG. 8 shows such a center-of-mass formation in the example of measuring electrode ME2. The reset section d0 per time value tm yields the average transport speed.

To determine the mass flow, it is sufficient for most applications to detect the average transport speed and the speed profile via measuring technology. For the distribution of the particles in the conveyor conduit, very precise particle distribution models are available that take into consideration the effects of gravitational force and segregation. For practical use, a mass measurement via measurement of forces on an elastic hose is possible.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method for determining the velocity of a mass flow comprising powdered/granular bulk material in a conduit, comprising the steps of:
introducing, at at least one first point of the conduit, periodic disturbances in the mass flow that affect its electrical properties,
producing, at at least one second point that is situated downstream of the at least one first point, an electrical current through the mass flow using an electrode mechanism,
measuring changes in the electrical current based on temporarily occurring disturbances introduced in the flow via an evaluation circuit, and
determining the speed of the mass flow from the time dependency between measured changes and introduced disturbance.

2. The method as described in claim 1, further comprising the step of determining whether or not the introduced disturbances affect the complex conductivity of the mass flow, using the electrode mechanism and the evaluation circuit at the at least one second point.

3. The method as described in claim 2, further including the step of introducing at the at least one first point a medium into the mass flow whose conductivity noticeably deviates from that of the bulk material.

4. The method as described in claim 2, wherein the introduced disturbances induce a local change of the dielectric constant of the mass flow.

5. The method as described in claim 1, further comprising the step of producing an electrical disturbance field strength at the at least one first point.

6. The method as described in claim 5, wherein the field strength is selected to be great enough that periodic discharges occur.

7. The method as described in claim 1, wherein a displacement current is measured at the at least one second point using the electrode mechanism and the evaluation circuit.

8. The method as described in claim 1, wherein the frequency of the measured alternating current lies within the range of 10⁶ to 10⁹ Hz.

9. A device for carrying out the method as described in claim 1, for a measuring section of a conduit having the at least one second point downstream from the at least one first point, an article is provided for introducing periodic disturbances that affect the electrical properties of the mass flow at the at least one point of disturbance, and at the at least one second point an electrode mechanism is provided that is connected to an evaluation circuit.

10. The device as described in claim 9, wherein the article is an array of nozzles for injecting liquid into the mass flow where the nozzles are positioned at the at least one first point about the circumference of the conduit at angular intervals of 120° and the electrode mechanism comprises an array of six electrodes positioned at the at least one second point about the circumference of the conduit at angular intervals of 60°.

11. The device as described in claim 9, wherein an electrode mechanism has at least one electrode pair.

12. The device as described in claim 11, wherein an electrode mechanism is provided at each of at least two of the at least one second point that are situated at a distance from each other in the direction of flow.

13. The device as described in claim 12, wherein the electrode mechanism of each at least one second point has at least two electrode pairs.

14. The device as described in claim 12, wherein one of the electrodes of an electrode pair of the electrode mechanism is formed by a conductive conduit wall or a conductive section of the conduit wall.

15. The device as described in claim 14, wherein the other one of the electrodes of the electrode pair of the electrode mechanism is disposed on the outer side of the conduit insulated from the conductive conduit wall or conductive section of the conduit wall.

16. The device as described in claim 12, wherein a separate evaluation circuit is provided for the electrode mechanism of each at least one second point.

17. The device as described in claim 12, wherein each electrode pair of different ones of the at least one second point are connected in parallel and connected to a common evaluation circuit.
